(19) United States
(12) Patent Application Publication
(10) Pub. No.: US 2013/0166194 A1
(43) Pub. Date: Jun. 27, 2013

(54) METHOD AND DEVICE FOR ASSISTING IN DRIVING AND ANTICIPATING A ROAD PROFILE

(71) Applicant: Vincent Delahaye, Gallardon (FR)

(72) Inventor: Vincent Delahaye, Gallardon (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/814,806

(22) PCT Filed: Aug. 3, 2011
(86) PCT No.: PCT/EP2011/003880

§ 371 Date: Mar. 14, 2013

(30) Foreign Application Priority Data
Aug. 13, 2010 (FR) 1003362

(51) Int. Cl. G01C 21/36

(52) U.S. Cl. CPC G01C 21/3667
USPC 701/410

(57) ABSTRACT

A method of assisting in road navigation for a vehicle includes:
identifying the active route of the vehicle from a navigation system including elements for locating the vehicle and mapping,
extracting, from calculating elements, a plurality of radii of curvature of the active route which are calculated from a first sampling of points of the active route,
calculating:
   the points of the active route corresponding to curvature angle inversions, the active route between two curve inversions representing a bend, and
   the length of each section of the active route between two consecutive inversion points;
generating a road profile including at least generating a section in a referential system in which the radius of curvature is a function of the length of the bend, and
displaying the generated road profile.

The present invention relates to devices for assisting in steering and driving on roads. More particularly, the device of the invention relates to the field of systems of navigation and of assisting in reading a road profile. Finally, the invention relates to devices for assisting in driving on roads having winding routes and potentially comprising many variations in radii of curvature, such as country or mountain roads.

Currently, in the field of road navigation assistance, there are many systems for providing multiple pieces of information intended for the driver of a vehicle and facilitating the driving thereof. Included among these systems are particularly systems of mapping data, of speed indicators, of guidance or traffic data. Furthermore, other systems allow the presence of radars to be detected or provide information on the capacity for overtaking or provide various alerts.

As regards navigating country roads or mountain roads that are winding to a greater or lesser degree, the lanes are generally reduced in width and the variation in the radii of curvature of the path followed or to be followed can be great and sporadic depending on the roads. Indeed, a slight bend can follow a large bend and at times on road portions the number of bends can become large. Driving on such roads can be dangerous. The driver of the vehicle must then dedicate all of his/her attention to driving and observing the variations in the curvature of the road. As a result, the driver is constantly required to adjust the speed to the bends while anticipating the bends as best as possible.

Currently, to overcome this situation, some systems can comprise a device of alerts when approaching a dangerous bend, i.e. which comprises a large radius of curvature.

Nevertheless, the driver can be surprised when aiming to anticipate a road profile comprising a series of bends. Furthermore, these last systems often require a configuration depending on the type of roads. Moreover, the transmission of a large number of alerts can become an annoyance for the driver.

Mapping devices, when coupled with a GPS geolocation system, generally propose a route of the road profile on which the vehicle moves along. One problem is that the representation is not suited to country or mountain driving on winding roads. Indeed, the representation of the road profile in 3D of a mapping can be distorted in terms of perspective and the driver is not able to realize the size of the bends when they follow one another. The analysis of such a representation by the driver requires a special level of attention, which is inappropriate to the special driving circumstances.

The other representations also have the disadvantage of not being able to show a series of bends such that the driver of the vehicle can compare them with each other without distortion.

Particularly, no tool for showing a series of bends allows comparison, at a glance, of the bends with one another in relation to a same scale such as to adjust driving to the path under the best conditions.

The invention allows this disadvantage to be resolved.

An aim of the invention is to propose to the driver of a vehicle assistance in anticipating a series of bends which can occur on small winding roads.

An aim of the invention is to generate a road profile showing the curvature of the route of the road to be followed as a function of a distance to be traveled.

The invention further allows increased recognition of the dangers of a winding road while best adapting a cruising speed that is pleasant for the passengers.

Advantageously, the method of assisting in road navigation for a vehicle includes:
a step of identifying the traffic lane, noted as the active route, of the vehicle from a navigation system including means for locating the vehicle and mapping including the routes of the traffic lanes in a given area,
   characterized in that the method includes:
a step of extracting, from calculating means, a plurality of radii of curvature of the active route which are calculated from a first sampling of points of the active route,
a step of calculating:
   the points of the active route corresponding to curvature angle inversions, the active route between two curve inversions representing a bend, and
   the distance to be traveled between two consecutive inversion points;
a step of generating a road profile including generating at least one section between two inversion points in a referential system in which the radius of curvature is a function of the length of the bend, and
a step of displaying the generated road profile.

Advantageously, the referential system includes a y-axis showing the distance to be traveled and an x-axis showing the value of the radius of curvature of the active route.

Advantageously, the usual position of the vehicle is an inversion point.

Advantageously, the first sampling is a function of the zoom factor of a predetermined area.

Invention also relates to a device for assisting in road navigation including calculating means for extracting an active route from a navigation system including means for locating the vehicle and mapping including the routes of the traffic lanes in a given area and for calculating a set of radii of curvature of the active route according to the method of the invention, said device including a display for showing the road profile according to the method of the invention.

Advantageously, selecting means allow the zoom factor to be adjusted according to the method of the invention.

Advantageously, control means allow a display mode to be chosen from at least two display modes corresponding, in a first instance, to showing the road profile and, in a second instance, to showing the mapping on which the road profile is superimposed.

Other features and advantages of the invention will be presented in a detailed description illustrated by the following figures, using the following description with reference to the appended drawings wherein:

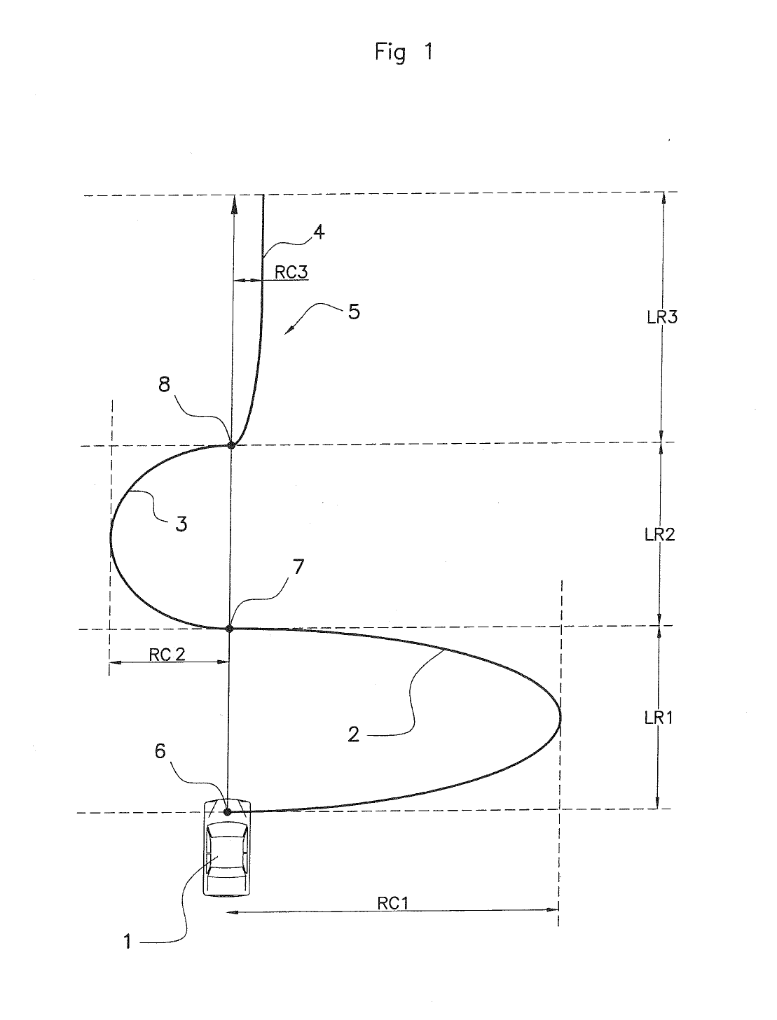

FIG. 1 shows the generation of a road profile according to the device of the invention,

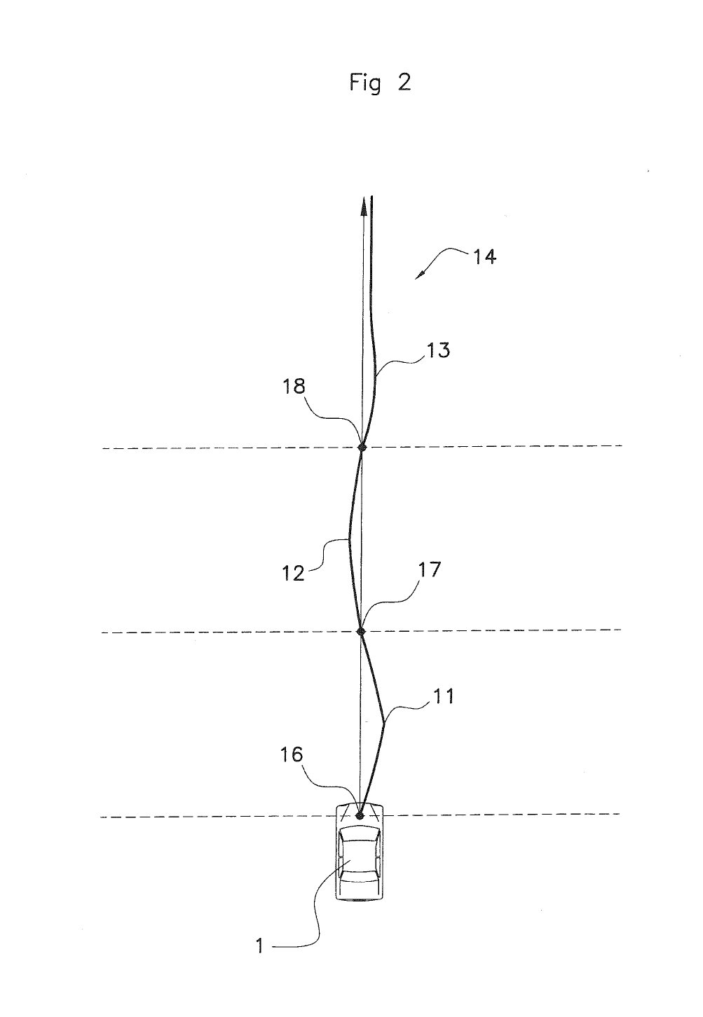

FIG. 2 shows the generation of a second road profile according to the device of the invention,

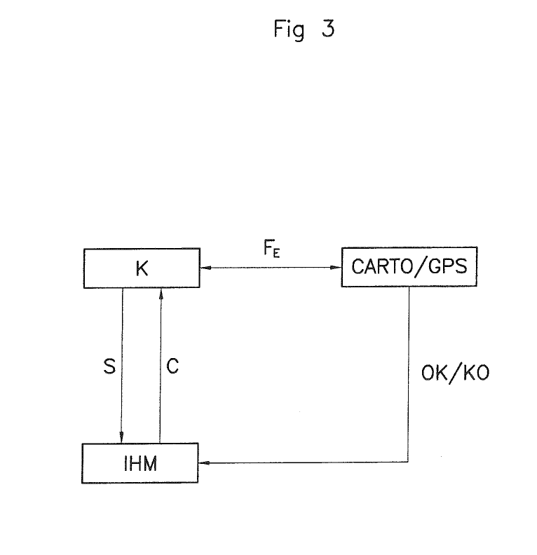

FIG. 3 shows a process diagram of the device of the invention.

FIG. 1 shows a road profile generated by the method of the invention and shown on a display of a vehicle.

The display includes the representation of:
the road profile made up of a curve 5 showing, in the x axis, the curvature of the consecutive bends and, in the y-axis, the remaining distance to be traveled,
a symbol 1 showing the vehicle in a position of the road profile 5.

The generated road profile 5 includes a series of points corresponding to values of radii of curvature on the x-axis. According to convention and the angle of curvature, the positive x-axis points correspond to a right-hand bend and the negative x-axis points correspond to a left-hand bend. It can be seen in FIG. 1 that the road profile includes three sections 2, 3, 4 each corresponding to a bend.

Each section comprises a point corresponding to the maximum radius of curvature in the section. This is the crest of the horizontal lobes shown. The maximum value for each section is noted as RC1, RC2 and RC3 respectively.

A distance to be traveled by the vehicle noted as LR1, LR2 and LR3 respectively corresponds to each section 2, 3, 4.

Each distance to be traveled is seen directly on the y-axis. In one embodiment, the y-axis is graduated.

The set of the absolute values of the radii of curvature in a single section is between 0 and RCn, where n is the nth bend ahead in the road and RCn is the maximum radius of curvature of the nth bend.

Advantageously, the general appearance of the curve 5 is shown such that a driver can simply evaluate the route and the curvature of the approaching bends, and therefore ‘in fine’ the danger which may potentially arise. This evaluation allows the driver to take corrective actions for the vehicle speed as a result of anticipation.

Particularly, in the first instance, the invention allows the driver to assess at a glance the number of bends of the route over a predefined distance as well as the development of the curvature thereof.

The driver can then, in advance, take the actions necessary for maintaining a fluid speed and take into consideration possible braking.

In one embodiment, the data for plotting the road profile from the method of the invention comprise a first step of identifying the traffic lane on which the vehicle is driving.

The invention allows this first step to be carried out using a navigation system including means for locating the vehicle and mapping including the routes of the traffic lanes in a predetermined area. The locating means can be a GPS in one embodiment.

The correlation of the vehicle location point and of the coordinates of the traffic lanes allow the traffic lane on which the vehicle is driving to be determined, this lane being called the “active route” in the rest of the description.

The invention allows, in a second step called an extraction step, using calculating means, for extraction of a plurality of radii of curvature of the active route which are calculated from a first sampling of points of the active route.

According to the embodiments, the sampling parameters can be adjusted such as to optimize the calculations of the points for which the calculations are carried out. For example, sampling providing continuity of the bearings of the radii of curvature of the route can be carried out while retaining a suitable resolution of the generation of the road profile according to the invention.

In an alternative embodiment, a zoom factor allows for enlargement or reduction of the predetermined area in which the road profile of the invention is generated. Sampling of the active route can, in one embodiment, be a function of the zoom factor.

In a third step, the method of the invention includes a step of calculating firstly the points of the active route corresponding to curvature angle inversions. Between two curve inversions, the active route can be likened to a bend.

Secondly, the third step includes calculating the length of each section of the active route between two consecutive inversion points.

Finally, the method of the invention includes a step of generating a road profile including at least the generation of a section in a referential system wherein the radius of curvature is a function of the length of the bend.

FIG. 1 shows a road profile 5 including three sections. A first section 2 shows a curve resulting from sampling of the radii of curvature between two angle inversions. The starting point 6 of the curve corresponds to the usual position of the vehicle 1 and defines a first inversion point and the inversion point 7 corresponds to the second curvature angle inversion point of the active route.

The invention allows at least one bend of the active route to be shown, but depending on the zoom factor, a plurality of bends can be taken into account. Particularly, one embodiment allows the road profile to be generated as a function of a certain number of inversion points such that, for example, the driver can constantly have the next three bends, for example in view.

In another embodiment, the zoom factor is fixed and shows at least the first inversion point which corresponds to the position of the vehicle.

FIG. 2 shows a road profile 14 in the case where the approaching bends have a small radius of curvature. The sections 11 and 12 are close to the vertical axis therefore showing a configuration in which the driver evaluates that the bends ahead have a small curvature and do not present a danger requiring a large reduction in the speed thereof.

The road profile 14 includes a first inversion point 16 defined as the active position of the vehicle 1, a second inversion point 17 defining with the first inversion point a first section 11.

The road profile 14 includes a third inversion point 18 separating the sections 12 and 13 of the road profile 14.

The third section 13 is not included between two inversion points and, as a result, it is extended along the axis infinitely while drawing closer thereto. The invention allows the trend of the last bend to be shown when the last inversion point is not located in the predetermined area.

One embodiment allows a factor or a coefficient to be applied to the curvature of the bends or to the curve length allowing the driver to assess more easily the variations in the curvature of the bends.

A device for implementing the invention comprises an MMI (Man-Machine Interface) for parameterizing the representation of the road profile. It is possible for the driver to stretch or compress the depiction of the two axes of the referential system.

Depending on alternative embodiments, the symbology showing the vehicle is fixed in position and in orientation, the road profile moving by and oriented always such that the vehicle course is shown vertically.

In another embodiment, the symbology showing the vehicle is positionally fixed but is oriented according to how the bend is taken, the vertical course showing the orientation of the wheels in the axis of the motor vehicle.

The device of the invention includes a display such as to represent the road profile and the symbol representing the vehicle. Advantageously, this display can be an interface for configuring the representation either with appropriate mechanical selectors or with a software interface such as a touch or vocal interface, or by an interactive menu.

In one embodiment, the display can be the display of another piece of equipment having a menu such as to change to the representation for generating the road profile of the invention.

Finally, another embodiment allows the symbol of the vehicle to be generated at the bottom of the display. An advantage of this solution allows all of the space corresponding to the road profile ahead to be available in front of the vehicle.

One alternative embodiment allows the symbol of the vehicle to be shown in the centre of the display. An advantage of this solution is to present on the display a road profile portion to the driver that has already been traveled over and a portion to be traveled over, therefore increasing the awareness of the connection of the generated road profile to the actual road profile.

In one embodiment, the invention allows a piece of information to be generated for each section of the road profile indicating the degree of difficulty of the bends to be taken.

The degree of difficulty is assessed according to the average or maximum radius of curvature of a section defined between two inversion points. Therefore, this coefficient showing the degree of difficulty of a bend allows, at a glance by the driver, the speed of the vehicle to be adjusted to the difficulty of the road profile.

FIG. 3 shows a process diagram for an embodiment of the invention.

The device of the invention comprises calculating means, noted as K, which can be a calculator already existing in the onboard electronics or a dedicated calculator. The device further comprises a mapping database, noted as CARTO, and location means such as a GPS for determining the position of the motor vehicle on a map.

The invention allows, using an extraction function, noted as F_{E}, the active route to be extracted from the mapping database and from the position of the vehicle and a set of radii of curvature to be generated from the calculator K according to a sampling of points of the active route.

The calculator can then generate a road profile corresponding to the development of the value of the radii of curvature over a distance to be traveled.

The device of the invention therefore also comprises a display, noted as IHM. The calculator can then provide to the display IHM data representing the road profile and the position of the vehicle on this road profile.

In an embodiment, the display IHM comprises a selector for parameterizing the navigation mode. One mode, noted as C, allows a navigation mode to be defined according to the invention, which is suited to country or mountain roads. Therefore, for the safety of the driver and the passengers, the driver can move to a display mode simply and come back to another mode as a result of an equally simple action.

The generated road profile of the invention offers the advantage of drawing all of the attention of the driver to the development of the bends, the variation thereof and the curvature thereof.

In this mode, a map can be superimposed on the road profile allowing the driver to read information on the geographical situation while seeing the development of the curvature of the bends ahead.

In this last mode, one option allows the superimposition of the map to be activated by an indicator “OK/KO” which allows the display of the map to be chosen or not. This last display can therefore be coupled with the selection of the C mode.

Advantageously, various embodiments allow the calculating means to be shared such that the calculating means of the invention are either the GPS processor, or the processor of a multimedia radio, or the processor of a digital dashboard.

Advantageously, various embodiments allow the display means to be shared such that the display of the invention is either the same as the display of the dashboard, or the GPS display, or a head-up display HUD. In these last cases, selecting means allow changing from one display mode to another or allow a combination in the form of superimposition of the displays of the various functions.

In one embodiment, the display of the invention is a dedicated display, and it can be either incorporated into the dashboard, or positioned at the top of the windshield.

The invention allows, in a nominal representation mode, a distance to be taken into account which ranges from a hundred meters to one or more kilometers. This distance is configurable manually or automatically depending on the complexity of the road.

An advantage of the representation of such a road profile of the invention is that it is continuously animated as the vehicle makes progress. Indeed, the vehicle is at a first position at a time t1 and drives into a bend. At a time t2 after the time t1, the vehicle is in an advanced position in this same bend. The distance of the first section of the first lobe representing the first bend of the road profile has reduced. Therefore, the road profile of the invention is animated and allows the driver to be aware of the development of the position thereof on the road profile.

The invention offers many advantages, particularly for driving on country or mountain roads, and these particularly include:
simplicity in reading information,
fluidity in the development of the road profile, which is continuous,
anticipation of the actions to be undertaken when the values of the radii of curvature of a bend become large.

1. A method of assisting in road navigation for a vehicle including a step of identifying the traffic lane, noted as the active route, of the vehicle from a navigation system including means for locating the vehicle and mapping including the routes of the traffic lanes in a given area, characterized in that the method includes:
a step of extracting, from calculating means, a plurality of radii of curvature of the active route which are calculated from a first sampling of points of the active route,
a step of calculating:
the points of the active route corresponding to curvature angle inversions, the active route between two curve inversions representing a bend, and
the distance to be traveled between two consecutive inversion points;
a step of generating a road profile including generating at least one section between two inversion points in a referential system in which the radius of curvature is a function of the length of the bend, and
a step of displaying the generated road profile.

2. The method of assisting in road navigation for a vehicle as claimed in claim 1, characterized in that the referential system includes a y-axis showing the distance to be traveled and an x-axis showing the value of the radius of curvature of the active route.

3. The method of assisting in road navigation for a vehicle as claimed in claim 1, characterized in that the usual position of the vehicle is an inversion point.

4. The method of assisting in road navigation for a vehicle as claimed in claim 1, characterized in that the first sampling is a function of the zoom factor of a predetermined area.

5. A device for assisting in road navigation including calculating means for extracting an active route from a navigation system including means for locating the vehicle and mapping including the routes of the traffic lanes in a given area and for calculating a set of radii of curvature of the active route according to the method of the invention, said device including a display for displaying the road profile generated according to the method of the invention.

6. The device for assisting in road navigation as claimed in claim 5, characterized in that selecting means allow the zoom factor to be adjusted according to the method of the invention.

7. The device for assisting in road navigation as claimed in claim 5, characterized in that control means allow a display mode to be chosen from at least two display modes corresponding, in a first instance, to showing the road profile and, in a second instance, to showing the mapping on which the road profile is superimposed.

8. The method of assisting in road navigation for a vehicle as claimed in claim 2, characterized in that the first sampling is a function of the zoom factor of a predetermined area.

9. The device for assisting in road navigation as claimed in claim 6, characterized in that control means allow a display mode to be chosen from at least two display modes corresponding, in a first instance, to showing the road profile and, in a second instance, to showing the mapping on which the road profile is superimposed.
